(19) United States
(12) Patent Application Publication
(10) Pub. No.: US 2005/0084655 A1
(43) Pub. Date: Apr. 21, 2005

(54) Method for molding flat thin-plate molded product, and molded product

(75) Inventors: Takayuki Horie, Takefu-city (JP); Kenji Shimoshita, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 10/963,546

(22) Filed: Oct. 14, 2004

(30) Foreign Application Priority Data
Oct. 16, 2003 (JP) 2003-356182

(51) Int. Cl. B32B 3/00

(52) U.S. Cl. 428/156; 264/328.1; 264/334

(57) ABSTRACT

The present invention provides an injection molding method and a thin-plate molded product formed thereby. The method for forming as molded product a thin-plate molded product by injecting a molten material such as resin into a cavity of a mold formed of a fixed mold and a movable mold comprises disposing slide core molds defining the cavity across substantially a whole length on at least three directions of the thin-plate molded product, providing projections to the slide core molds that face the cavity, injecting molten resin into the cavity and cooling the same, moving the movable mold to open the mold, receding the slide core molds disposed on at least three directions of the thin-plate molded product, and projecting the molded product via eject pins provided to the fixed mold.

The present application is based on and claims priority of Japanese patent application No.2003-356182 filed on Oct. 16, 2003, the entire contents of which are hereby incorporated by reference.

### BACKGROUND OF THE INVENTION

1. Field of the Invention

The present invention relates to a method for molding a flat thin-plate molded product, especially used for example as an open/close cover panel for hiding manipulation units of electronic devices such as television and audio devices, having a decorated front surface with multiple dimples or embossments and a substantially flat back surface, and to a molded product formed by this method.

2. Description of the Related Art

It has been well known that injection molding machines are utilized to form a molded product having a complex shape using plastic, and the injection molding machine used for such purpose is composed of a movable mold and a fixed mold which define therein a cavity corresponding to the shape of the product to be molded. Upon molding a product, a mold clamping pressure in the order of tens to hundreds of tons is provided to the movable mold with respect to the fixed mold, and in this state, molten material such as resin is injected into the cavity through an injection mechanism to mold the product. After cooling the molded product, the mold is opened, and eject pins provided to the fixed mold are projected to demold the molded product.

In this type of molding using a generic injection molding machine, there occur cases in which the completed molded product cannot be demolded smoothly from the mold. Especially when demolding a molded product which is of flat thin-plate form with relatively fine uneven patterns (dents or projections) such as dimples or embossments formed on its surface, it is difficult to remove the molded product without fail, since the uneven pattern on the surface of the molded product causes the product to be adhered to and pulled by the movable mold during opening of the mold and forced to be detached from the fixed mold, by which the molded product is deformed or cracked. That is, even if the molded product is of thin plate form, if the front and back surfaces are smooth with little unevenness, the above problem will not occur. However, in the case of a thin-plate molded product in which the front surface has multiple uneven patterns while the back surface is flat with only a small number of reinforcement ribs etc. formed thereto, the surface attached to the movable mold is difficult to demold, and during opening of the mold, the molded product tends to follow the movement of the movable mold, which causes the product to be cracked and damaged since the product is thin. Therefore, defective products that could not be used as product were manufactured. Thus, in manufacturing a molded product to be applied to electronic devices for example, it was practically difficult to manufacture a thin plate-shaped molded product having decorations such as multiple dimples or embossments on the front surface and a flat back surface.

Further, for example, Japanese patent laid-open publication No. 2003-236897 discloses a method for releasing a molded product from a mold. However, the injection molding machine disclosed here removes the molded product attached to the movable mold by having a fitting portion formed to the end of a runner lock pin engage with the molded product to remove the molded product easily from the mold, so the fitting portion is passed through the surface of the molded product to engage with the molded product. Thus, if it is not preferable to have ahole formed to the surface of the molded product, the disclosed method for releasing the molded product from the mold is not desirable. Further, since an annularly recessed portion of the runner lock pin is fit to the molded product, upon pulling the molded product away from the runner lock pin, the hole formed on the molded product is widened and may cause the area near the hole of the product to be damaged.

### SUMMARY OF THE INVENTION

The present invention aims at solving the above-mentioned problems of the prior art, and provides a method for reliably removing a thin-plate molded product having a front surface with multiple continuous dimples or embossments and a back surface that is relatively flat from a mold without damaging the product, and a molded product formed by this method. The present molded product is especially suitably used in electronic devices.

The present invention provides as a first aspect of the invention an injection molding method for molding a flat thin-plate molded product by injecting a molten material such as resin into a cavity of a mold formed of a fixed mold and a movable mold, wherein the molding method comprises disposing slide core molds defining the cavity across substantially a whole length on at least three directions of the thin-plate molded product, providing projections to the slide core molds that face the cavity, injecting molten resin into the cavity and cooling the same, moving the movable mold to open the mold, receding the slide core molds disposed on at least three directions of the thin-plate molded product, and projecting the molded product via eject pins provided to the fixed mold.

The present invention provides as a second aspect of the invention a method for molding a flat thin-plate molded product mentioned above, wherein the thin-plate molded product has uneven patterns such as multiple dimples or embossments formed on a surface facing the movable mold, which makes it difficult to remove said molded product from the mold. Since it is difficult to remove the product from the mold, the present invention can exert further effectiveness.

The present invention provides as a third aspect of the invention a method for molding a flat thin-plate molded product mentioned above, wherein the projections formed across substantially a whole length on at least three directions of the slide core molds defining the cavity and facing the cavity form engagement grooves on three directions of the thin-plate molded product.

The present invention provides as a fourth aspect of the invention a flat thin-plate molded product having a small thickness and formed of resin, wherein a front surface of the molded product is provided with multiple fine dimples or embossments arranged in lattice-like form, a back surface of the molded product is formed substantially flat, and engagement grooves are formed at least on three side surfaces thereof across substantially the whole length thereof. Further, the present invention provides as a fifth aspect of the invention a thin-plate molded product having, in addition to the features mentioned above, a thickness in the range of 2 to 3 mm.

According to the first aspect of the present invention, upon molding a flat thin-plate molded product and moving a movable mold to open the mold, slide core molds having projections disposed on at least three directions of the thin-plate molded product are receded, and then eject pins provided on the fixed mold are projected to push the molded product out of the mold. Thus, the flat thin-plate molded product is engaged by projections when the movable mold is removed, so the molded product will not be damaged by this movement and can be removed from the mold smoothly without fail, and therefore, the productivity is improved.

According to the second aspect of the present invention, the flat thin-plate molded product has uneven patterns such as multiple dimples or embossments formed on a surface facing the movable mold, but the molded product having such design which was difficult to remove from the mold conventionally can be removed easily from the mold according to the present invention.

According to the third aspect of the present invention, the projections formed along substantially a whole length on at least three directions of the slide core mold defining the cavity and facing the cavity form engagement grooves on three directions of the thin-plate molded product, so that the molded product is engaged by the projections when the movable mold is separated. Therefore, even if the molded product has a complex uneven pattern formed thereon which makes it difficult to separate from the mold, the product can reliably be removed smoothly from the mold.

According to the fourth aspect of the present invention, the thin-plate molded product has a small thickness and formed of resin, wherein a front surface of the molded product is provided with multiple fine dimples or embossments arranged in lattice-like form, a back surface of the molded product is formed substantially flat, and engagement grooves are formed at least on three side surfaces thereof across substantially the whole length thereof. Further, according to the fifth aspect of the invention, in addition to the fourth aspect mentioned above, the thickness of the thin-plate molded product is 2 to 3 mm. Therefore, even if the molded product is thin, it has multiple dimples or embossments which enhance its strength and increase its flexibility. Therefore, even if relatively large force is applied to the molded product from the exterior, the molded product will not break easily since it has sufficient flexibility. Further, since the molded product has reduced thickness, it enables more efficient use of space.

### BRIEF DESCRIPTION OF THE DRAWINGS

FIG. 1 is a cross-sectional view of a mold for an injection molding machine according to the present embodiment;

FIG. 2 is an enlarged cross-sectional view showing the main portion of the mold for the injection molding machine mentioned above;

FIG. 3 is an enlarged cross-sectional view taken along line A-A of FIG. 1 of the mold for the injection molding machine mentioned above;

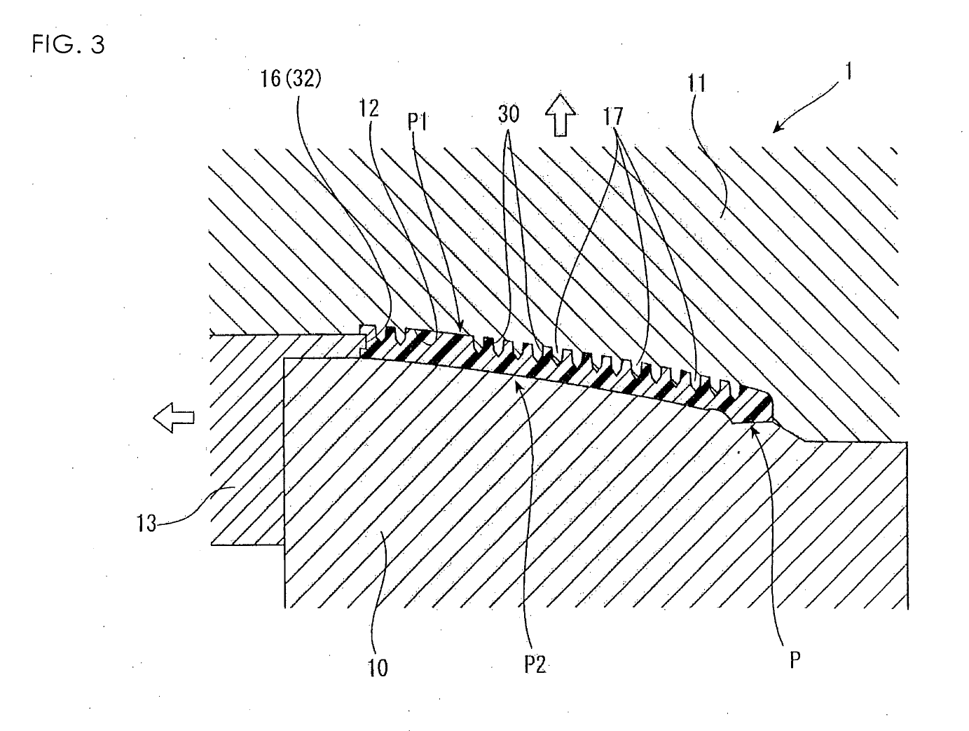

FIG. 4 is a front view of a molded product according to the present embodiment;

FIG. 5 is a plan view of the above-mentioned molded product;

FIG. 6 is a back view of the above-mentioned molded product;

FIG. 7 is a left side view of the above-mentioned molded product;

FIG. 8 is an enlarged cross-sectional view taken along line B-B of the above-mentioned molded product; and

FIG. 9 is a cross-sectional view showing the state in which the mold for injection molding is opened according to the present embodiment.

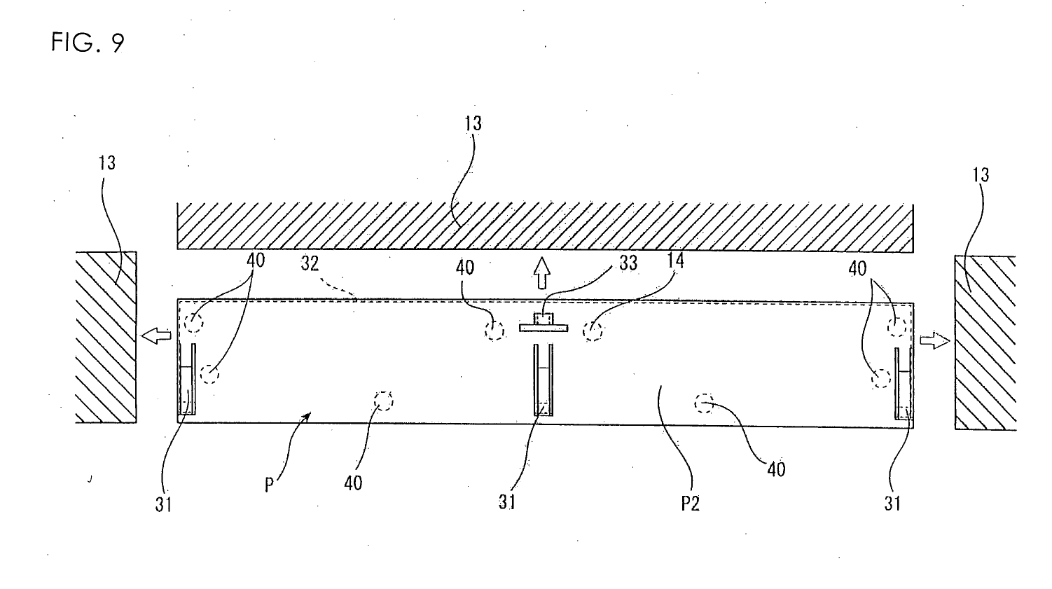

### DETAILED DESCRIPTION OF THE PREFERRED EMBODIMENT

Now, the best mode for carrying out the present invention will be described with reference to the accompanied drawings, but the illustrated embodiment shows only an example of the present invention, and it is not intended to limit the present invention to the structure illustrated in the drawings.

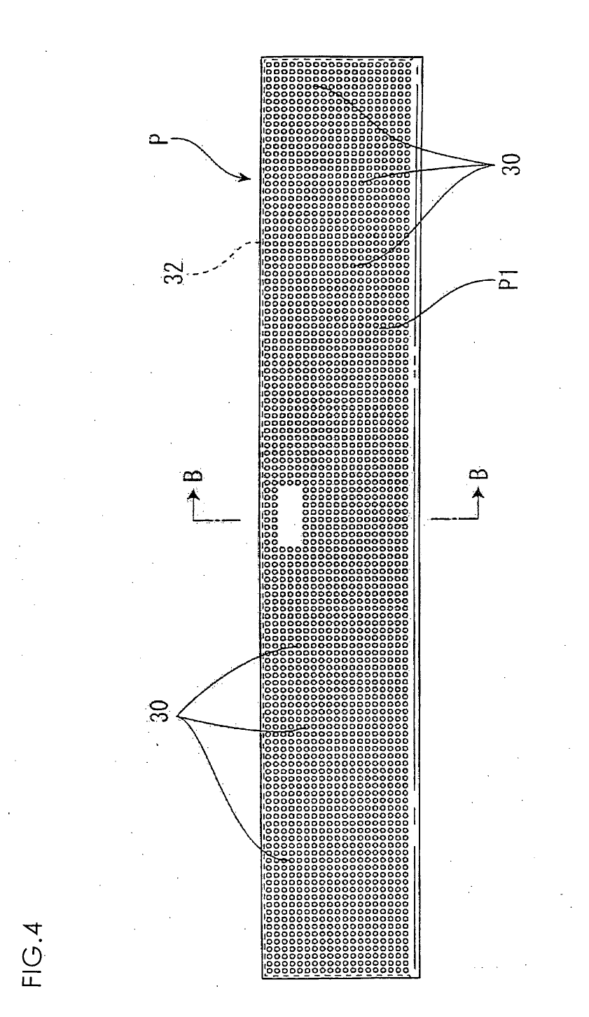

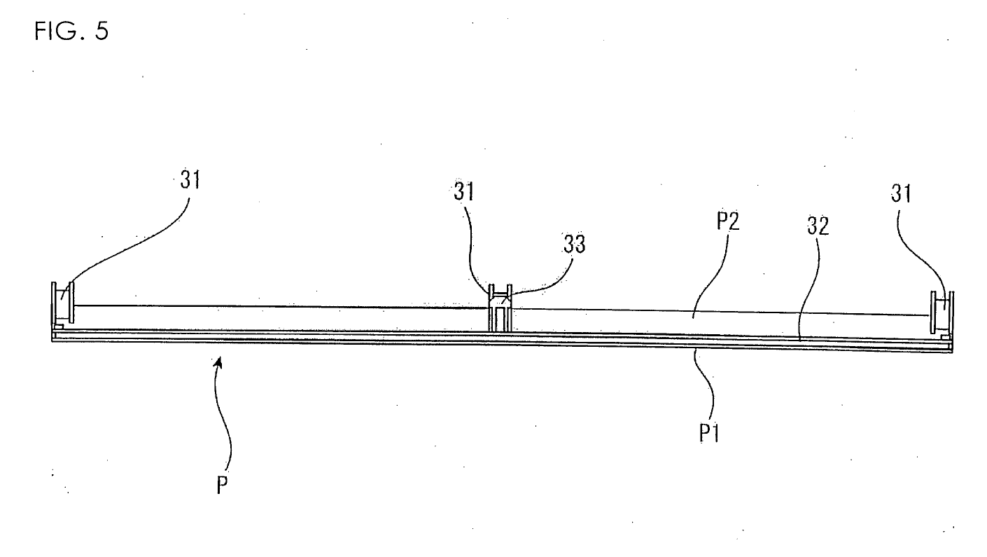

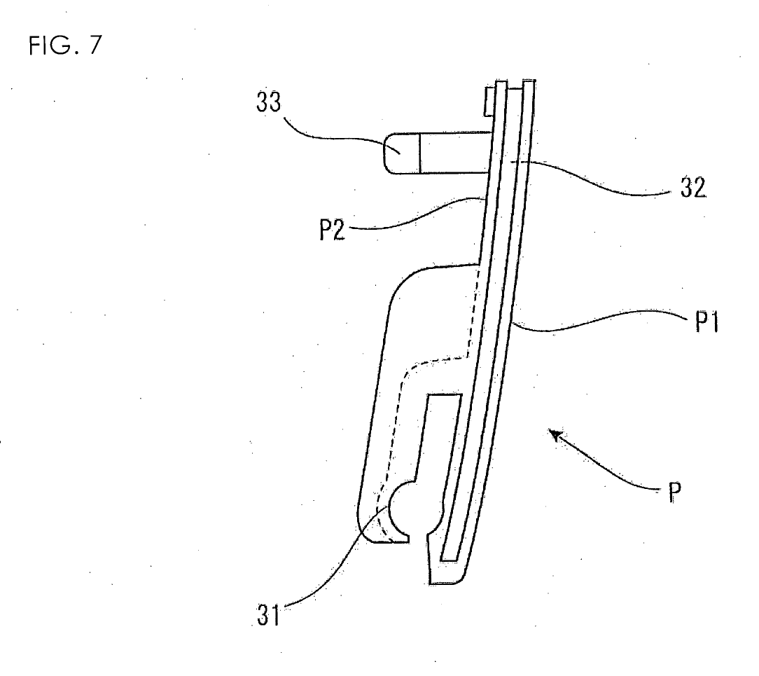

At first, a molded product P which is the target product to be formed according to the present invention will be described with reference to FIGS. 4 through 8. FIG. 4 is a front view of a molded product according to the present embodiment.

P is a molded product formed by injecting and molding a molten material such as resin via injection molding. The molded product P according to the present embodiment is used for example as a panel for covering manipulation switches of television receivers equipped with a liquid crystal monitor or other electronic devices.

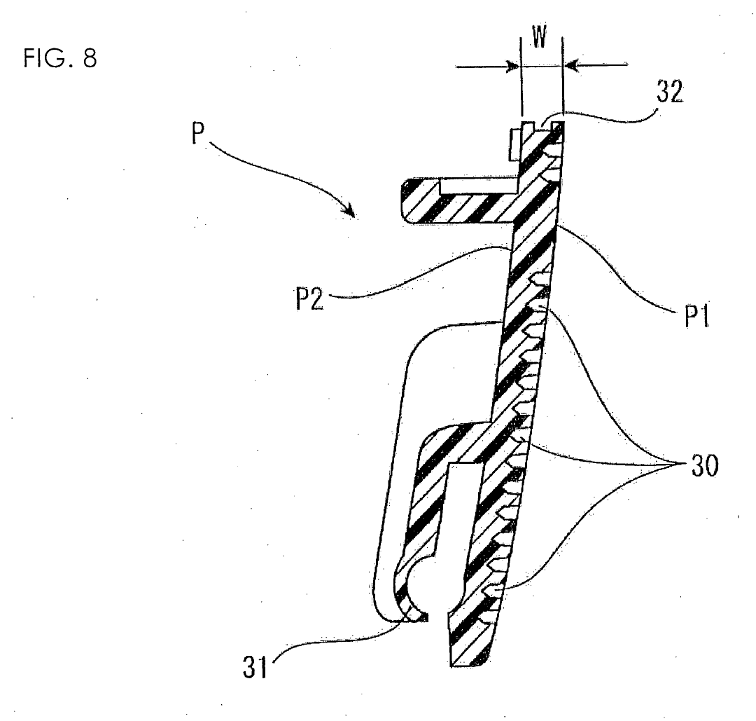

The overall shape of the molded product P is a horizontally longitudinal rectangle, with a cross-section formed smoothly in a somewhat curved shape as shown in FIG. 8, and the thickness W thereof is 5 mm or below, preferably 2 to 3 mm, and in practice, 3 mm, so that the thickness thereof formed by molding is very thin. If this molded product P is used as a panel of a manipulation unit for a television receiver body equipped with a liquid crystal monitor, it becomes possible to further reduce the thickness and weight of the area near the manipulation unit of an electronic device.

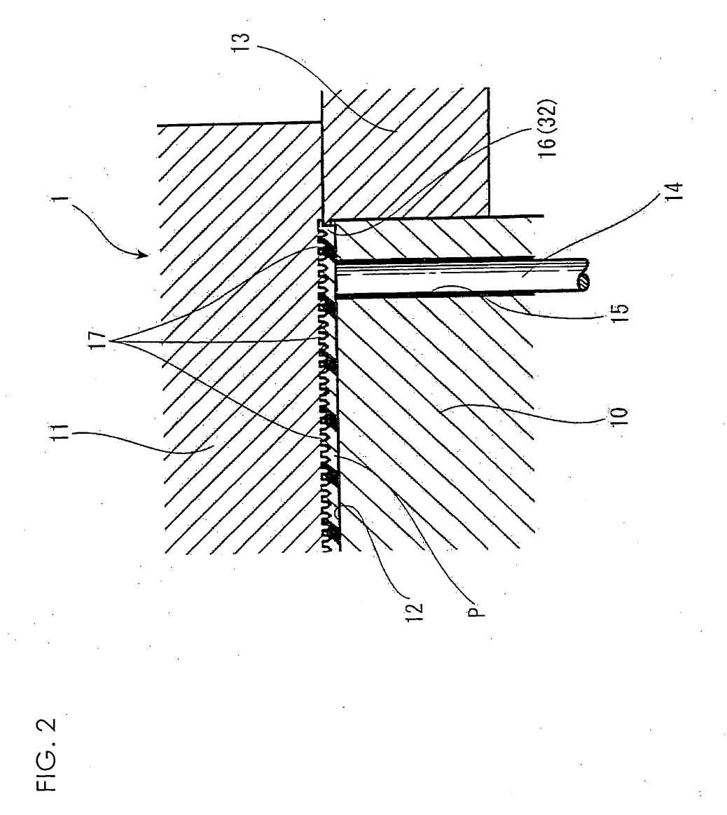

Further, dimples 30 having multiple circular fine dents as shown in FIG. 2 are formed continuously in lattice-like arrangement in horizontal and vertical directions on a front face P1 of the molded product P, and this process not only enables the front surface of the molded product P to be formed as a decorated face but also enables the molded product P to have enhanced flexibility and reduced weight. Therefore, the molded product P of the present embodiment is less likely to be defective compared to a simple flat plate-shaped molded product. At this time, the forming of embossments instead of the dimples is merely a design choice to be determined by those skilled in the art. Further, though not especially illustrated, by varying the design of the dimples, it is possible to have letters such as the company name or marks to be embossed.

On the other hand, pivot support portions 31 for pivotally supporting the molded product P on a television receiver body mentioned previously are formed on appropriate portions on a back surface P2 of the molded product P integrally with the molded product P, so as to enable the molded product P to be used as a cover capable of being opened and closed.

Moreover, engagement grooves 32 capable of being engaged by projections 16 on the above-mentioned slide core mold 13 are formed in angulated U-shape on at least three side rims on the peripheral rim of the molded product P, more specifically, on the upper rim and both side rims of the molded product P, as shown in FIG. 4.

Further, an engagement portion 33 that can be fit loosely to the television receiver body is formed on the upper center area on the back surface P2 of the molded product P. By having the engagement portion 33 fit loosely onto a portion of the television receiver body, it is possible to open and close the molded product P so as to cover and uncover a manipulation unit or the like provided to the television receiver. Other than the pivot support portions 31 and the engagement portion 33, the surface of the back surface P2 of the molded product P is formed substantially flat.

Thus, even if the molded product P has a very small thickness, since it is provided with multiple dimples, the product will have enhanced strength and flexibility. Therefore, even if a relatively strong force is applied thereto from the exterior, the molded product will not be damaged thanks to its flexibility. Further, since the thickness of the molded product can be reduced, the product will enable more efficient use of space.

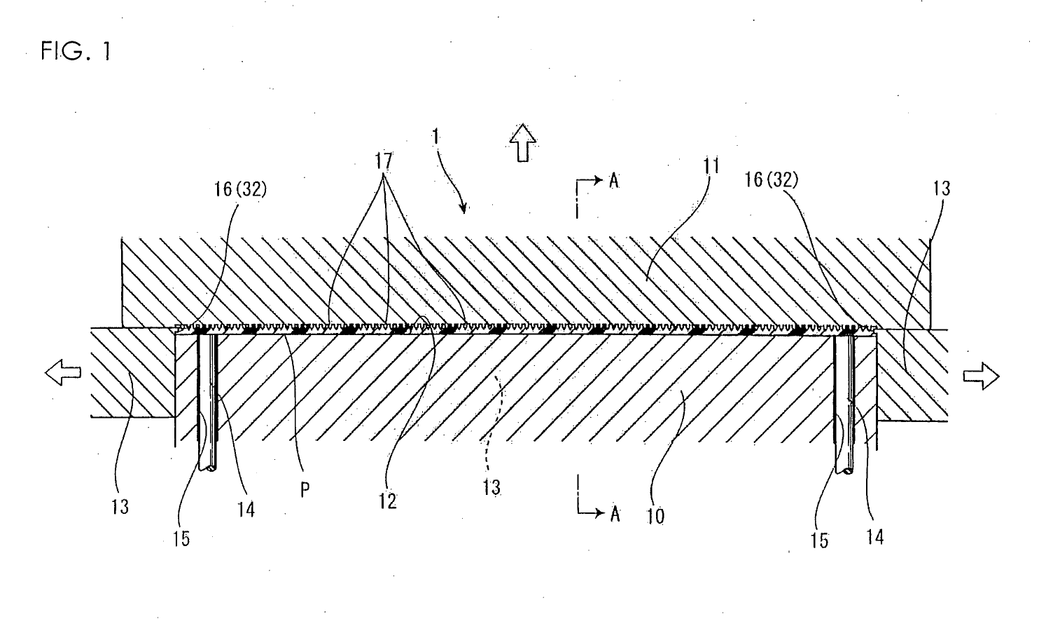

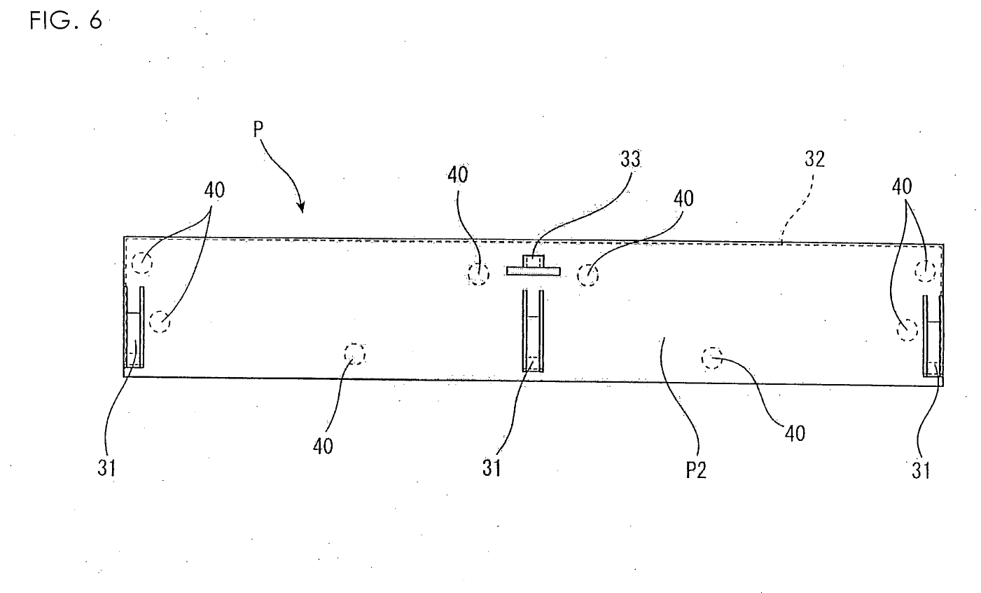

Next, the mold for forming the molded product P will be described. Reference number 1 denotes a mold for injection molding, and the mold for injection molding 1 has a cavity 12 acting as a mold for the molded product P defined by the surfaces of at least a fixed mold 10 and a movable mold 11 facing each other, and on at least three sides facing this cavity 12 are respectively disposed a slide core mold 13, as shown in FIG. 1. The fixed mold 10 is provided with plural eject pins 14 that can be projected from the mold to release the molded product P formed in the cavity 12 after opening the mold. The eject pin 14 has a round cross-section, and as shown in FIG. 1, it slides along a hole 15 formed perpendicularly with respect to the cavity 12. There are eight eject pins which are disposed separately at locations shown by dotted circles in FIG. 6 (showing projection marks 40 of the eject pins) so as to have the demolding force act uniformly on the molded product P.

Further, each slide core mold 13 has a projection 16 formed to face the cavity 12 for engagement with the molded product P formed in the cavity 12, and according to the present embodiment for molding a molded product P which is of thin rectangular plate form as described later, the projections 16 are formed at least in an angulated U-shape along the surfaces of the slide core molds 13 facing the cavity 12 to correspond to the three peripheral rims of the molded product P.

Further, on the surface of the movable mold 11 facing the cavity 12, there are formed a plurality of projected portions 17 which are round and continuously formed in lattice-like arrangement.

According to the present embodiment, projected portions 17 are formed on the surface of the movable mold 11 facing the cavity, but it is also possible to form the projected portions on the fixed mold 10 instead of the movable mold 11. Moreover, the shape of the projected portions can be rectangular instead of round, and other similar variations are possible to still achieve the effects of the present embodiment mentioned later.

Next, we will describe the method for molding a thin plate-shaped molded product using an injection molding machine according to the present embodiment.

As shown in FIG. 1, according to a mold clamping action performed by the injection molding machine, a mold clamping pressure in the order of tens to hundreds of tons is provided while the cavity 12 is being defined by the fixed mold 10, the movable mold 11 and the slide core molds 13, and in this state, molten material such as resin is injected into the cavity 12 from an injection mechanism not shown.

After the injection is completed and a cooling process passes, the molten material in the cavity 12 hardens. Then, the movable mold 11 is moved to the upper direction in FIG. 1 with respect to the fixed mold 10 and the mold is opened to remove the molded product P from the cavity 12. In practice, an injection molding machine that opens and closes the mold along the horizontal direction is commonly used. In that case, by engaging the molded product P in the form of a thin-plate by the projections 16 formed on the slide core molds 13 facing the cavity 12, it is possible to reliably prevent the action of the thin-plate molded product P being pulled by the movable mold 11 along with the movement of the movable mold 11 without being released from the mold, and instead, have the thin-plate molded product P held securely within the cavity 12 of the fixed mold 10. Therefore, even a molded product P having multiple dimples 30 formed by the movable mold 11 and thus not easily released from the movable mold 11 can be released from the mold reliably and easily without being damaged.

Even if the molded product P is a flat, thin plate product, if the front and back surfaces of the product are relatively flat or if the back surface is provided with reinforcement ribs etc., the molds can be opened without such problem. However, according to the present invention, since fine continuous dimples or embossments are provided on the front surface of the thin-plate molded product while the back surface thereof is relatively flat, the above-described molding method is indispensable.

Next, the slide core molds 13 engaging the molded product P by the projections 16 are each receded away from the cavity to enable demolding of the product, and finally, the eject pins 14 are moved in the upper direction shown in FIG. 1 to demold from the fixed mold 10 the molded product P attached to the surface of the fixed mold 10 facing the cavity. The molded product P is projected by this movement, and the molded product is released from all the molds.

As described, according to the method for molding a thin-plate molded product P, the mold 1 of the injection molding machine for forming a molded product P by molding a molten material such as resin is composed of a fixed mold 10 and a movable mold 11 defining a cavity 12, and a slide core mold 13 also defining the cavity 12 together with the fixed mold 10 and movable mold 11, wherein the slide core mold 13 is provided on at least three directions of the cavity 12 and having projections 16 facing the cavity 12, and the movable mold 11 has multiple fine projected portions 17 arranged in lattice-like form on the surface facing the cavity 12. When the movable mold 11 is opened, the molded product P is engaged by the projections 16 and held on the side of the fixed mold, so that the thin-plate molded product P having a deteriorated demolding property due to the multiple projected portions 17 being formed increasing the surface area thereof can still be engaged by the projections 16, by which the molded product P is prevented from being damaged. The molds can be opened reliably and smoothly, enabling the molded product to be demolded.

Moreover, since the projected portions 17 are round, they have no edges compared for example to angular shaped projected portions, so the molded product can be released from the mold with a rather small demolding force from the injection molding machine 1, and so the molded product P can be released from the mold easily using a small number of eject pins without applying any unreasonable force.

Further according to the present method, the mold comprises slide core molds 13 defining the cavity 12, projections 16 formed on the slide core molds 13 and facing the cavity 12, a fixed mold 10 and a movable mold 11 defining the cavity 12 together with the slide core molds 13, wherein the surface of the movable mold 11 facing the cavity has multiple fine lattice-like dented or projected patterns formed thereto, so that the molded product P is engaged by the projections 16 when the movable mold is released from the molded product. Therefore, the molded product P is engaged at least on three directions by the projections 16 when the movable mold 11 is released, and the molded product P is demolded thereafter, so even the molded product P having complex dented or projected patterns which deteriorate the demolding property of the product P can still be smoothly released from the mold without fail.

Moreover, the present molded product P is a thin-plate product P formed of resin with multiple fine dimples 30 arranged in lattice-like form on the front surface of the molded product P while the back surface thereof is substantially flat, wherein the multiple fine dimples 30 formed on the front surface is continuously arranged in lattice-like form, and the thickness of the molded product P is 2 to 3 mm. Therefore, even if the thickness of the molded product P is small, the plurality of dimples formed thereon will enable its weight to be reduced, its flexibility to be enhanced and its strength to be maintained, so even when a relatively large force is applied thereto from the exterior, the molded product P will not be damaged. Further, since the molded product P can have reduced thickness, effective use of space is enabled when the molded product P is attached for example to electronic devices.

1. An injection molding method for molding a flat thin-plate molded product by injecting a molten material such as resin into a cavity of a mold formed of a fixed mold and a movable mold, wherein the molding method comprises:
disposing slide core molds defining said cavity across substantially a whole length on at least three directions of said thin-plate molded product;
providing projections to said slide core molds that face said cavity;
injecting molten resin into said cavity and cooling the same;
moving said movable mold to open the mold;
receding said slide core molds disposed on at least three directions of said thin-plate molded product; and
projecting said molded product via eject pins provided to said fixed mold.

2. The method for molding a flat thin-plate molded product according to claim 1, wherein the thin-plate molded product has uneven patterns such as multiple dimples or embossments formed on a surface facing said movable mold, which makes it difficult to remove said molded product from the mold.

3. The method for molding a flat thin-plate molded product according to claim 1 or claim 2, wherein said projections formed across substantially a whole length on at least three directions of said slide core molds defining said cavity and facing said cavity form engagement grooves on three directions of said thin-plate molded product.

4. A flat thin-plate molded product having a small thickness and formed of resin, wherein a front surface of said molded product is provided with multiple fine dimples or embossments arranged in lattice-like form, a back surface of said molded product is formed substantially flat, and engagement grooves are formed at least on three side surfaces thereof across substantially the whole length thereof.

5. The thin-plate molded product according to claim 4, wherein the thickness of the flat thin-plate molded product is 2 to 3 mm.
